(19) United States
(12) Patent Application Publication
(10) Pub. No.: US 2013/0140215 A1
(43) Pub. Date: Jun. 6, 2013

(54) PROCESS FOR HYDROCRACKING A HYDROCARBON FEED IN THE PRESENCE OF A SULPHIDE CATALYST PREPARED USING A CYCLIC OLIGOSACCHARIDE

(71) Applicants: Fabrice Diehl, Lyon (FR); Audrey Bonduelle, Francheville (FR)

(72) Inventors: Fabrice Diehl, Lyon (FR); Audrey Bonduelle, Francheville (FR)

(73) Assignee: IFP ENERGIES NOUVELLES, RUEIL-MALMAISON CEDEX (FR)

(21) Appl. No.: 13/812,716

(22) PCT Filed: Jun. 24, 2011
(86) PCT No.: PCT/FR2011/000371

§ 371 Date: Feb. 25, 2013

(30) Foreign Application Priority Data
Jul. 29, 2010 (FR) 10/03181

(51) Int. Cl. B01J 29/14; B01J 23/883; C10G 47/02

(52) U.S. Cl. CPC B01J 29/146; C10G 47/02; B01J 23/883
USPC 208/112

(57) ABSTRACT

Hydrocracking a hydrocarbon feed in the presence of a catalyst comprising an acidic support and an active phase formed from at least one metal from group VIII and at least one metal from group VIB, said catalyst being prepared using a process comprising, in succession:
contacting a pre-catalyst comprising said metal from group VIII, said metal from group VIB and said acidic support with a cyclic oligosaccharide of at least 6α-(1,4)-bonded glucopyranose subunits;
contacting the acidic support with a solution containing a precursor of metal from group VIII, a precursor of said metal from group VIB and a cyclic oligosaccharide of at least 6α-(1,4)-bonded glucopyranose subunits; and
contacting acidic support with a cyclic oligosaccharide of at least 6α-(1,4)-bonded glucopyranose subunits followed by a second contacting acidic solid with a precursor of metal from group VIII and a precursor of metal from group VIB;
drying;
heat treatment;
sulphurization.

### FIELD OF THE INVENTION

The present invention relates to the field of processes for hydrocracking (HCK) hydrocarbon feeds wherein at least 20% by volume comprises compounds with a boiling point of 340° C. or more. The aim of the process is essentially the production of middle distillates corresponding to kerosene and gas oil cuts, i.e. cuts with an initial boiling point which is preferably at least 150° C. and an end point which is preferably at most 370° C., or even at most 340° C.

### PRIOR ART

The hydrocracking of heavy oil cuts is a very important refining process which can produce, from surplus and poorly upgradeable feeds, lighter fractions such as gasolines, jet fuels and light gas oils; the refiner has to adapt supply thereof to demand. Certain hydrocracking processes can also produce a highly purified residue which can provide excellent base oils. Compared with catalytic cracking, catalytic hydrocracking is of interest in the provision of very high quality middle distillates, jet fuels and gas oils. In contrast, the gasoline produced has a much lower octane number than that derived from catalytic cracking.

Hydrocracking is a process which derives its flexibility from three principal elements, namely the operating conditions used, the types of catalysts employed and the fact that hydrocracking of hydrocarbon feeds can be carried out in one or two-steps.

### Generalities Regarding Catalysts for Hydrocracking (HCK) Hydrocarbon Feeds

The composition and use of catalysts for hydrocracking hydrocarbon feeds are respectively described in the publication “Hydrocracking Science and Technology”, 1996, J Scherzer, A J Gruia, Marcel Dekker Inc and in the article by B S Clausen, H T Topsøe, F E Massoth in the publication “Catalysis Science and Technology”, 1996, volume 11, Springer-Verlag.

HCK catalysts are bifunctional in type: they combine an acid function with a hydrodehydrogenating function. The acid function is provided by porous supports the surface areas of which generally vary from 150 to 800 m²/g and have a superficial acidity, such as halogenated aluminas (in particular chlorinated or fluorinated), combinations of boron and aluminium oxides, amorphous or crystalline mesoporous aluminosilicates and zeolites dispersed in an oxide binder. The hydrodehydrogenating function is provided by the presence of an active phase based on at least one metal from group VIB and possibly at least one metal from group VIII of the periodic classification of the elements. The most common formulations are of the nickel-molybdenum (NiMo) and nickel-tungsten (NiW) type and more rarely of the cobalt-molybdenum (CoMo) type. After preparation, the hydrodehydrogenating function is frequently present in the oxide form. The active and stable form for HCK processes is the sulphide form, and so those catalysts have to undergo a sulphurization step. This can be carried out in an associated unit of the process (hence it is referred to as in situ sulphurization) or prior to loading the catalyst into the unit (hence it is referred to as ex situ sulphurization).

The balance between the two functions, acid and hydrodehydrogenating, is one of the parameters which governs the activity and selectivity of HCK catalysts. A weak acid function and a strong hydrodehydrogenating function produces less active catalysts working at a temperature which is generally high (390-400° C. or more) and with a low space velocity (HSV, expressed as the volume of feed to be treated per unit volume of catalyst per hour, generally 2 or less), but provided with a very good selectivity for middle distillates. In contrast, a strong acid function and a weak hydrodehydrogenating function produces active catalysts, but they have poorer selectivities for middle distillates (jet fuels and gas oils). One type of conventional HCK catalyst is based on moderately acidic amorphous supports such as mesoporous aluminosilicates, for example. Those systems are used to produce good quality middle distillates and optionally base oils. Such catalysts are, for example, used in once-through processes.

The skilled person is generally aware that good catalytic performances in the fields of application mentioned above are a function 1) of the nature of the hydrocarbon feed to be treated; 2) of the process employed; 3) of the operating conditions selected; and 4) of the catalyst used. In this latter case, it is also known that a catalyst with a high catalytic potential is characterized 1) by an optimized hydrodehydrogenating function (associated active phase properly dispersed at the surface of the support and having a high metal content); and 2) by a good balance between said hydrodehydrogenating function and the cracking function as mentioned above. It should also be noted that ideally, irrespective of the nature of the hydrocarbon feed to be treated, the catalyst must allow accessibility to the sites which are active as regards the reagents and reaction products while developing a high active surface area, which results in specific constraints in terms of structure and texture for the constituent oxide support of said catalysts.

The usual methods leading to the formation of the hydrodehydrogenating phase of HCK catalysts consist of depositing a molecular precursor or molecular precursors of at least one metal from group VIB and optionally at least one metal from group VIII on an acidic oxide support using the technique known as “dry impregnation” followed by maturation, drying and calcining steps leading to the formation of the oxide form of said metal(s) employed. Next comes the final step of sulphurization, generating the active hydrodehydrogenating phase as mentioned above.

The catalytic performances of the catalysts obtained from these “conventional” synthesis protocols have been studied in depth. In particular, it has been shown that for relatively high metals contents, phases appear which are refractory to sulphurization formed consecutive to the calcining step (sintering phenomenon) (B S Clausen, H T Topsøe, F E Massoth in the publication “Catalysis Science and Technology”, 1996, volume 11, Springer-Verlag). As an example, in the case of CoMo or NiMo type catalysts supported on an alumina type support, they are 1) crystallites of MoO₃, NiO, CoO, CoMoO₄ or Co₃O₄, of a size sufficient to be detected by X-ray diffractometry, and/or 2) species of the type Al₂(MoO₄)₃, CoAl₂O₄ or NiAl₂O₄. The three species cited above containing the element aluminium are well known to the skilled person. They result from interaction between the alumina support and the dissolved precursor salts of the active hydrodehydrogenating phase, which in fact means the reaction between Al³⁺ ions extracted from the alumina matrix and said salts to form Anderson heteropolyanions with formula [Al(OH)₆Mo₆O₁₈]³⁻, which are themselves precursors of phases which are refractory to sulphurization. The presence of all of those species results in a non-negligible, indirect loss of the catalytic activity of the associated catalyst since not all of the elements belonging to at least one metal from group VIB and optionally at least one metal from group VIII are being used to their maximum potential; a portion thereof is immobilized in slightly active or inactive species.

The catalytic performances of the conventional catalysts described above could thus be improved, in particular by developing novel methods for the preparation of said catalysts which could:

1) assure good dispersion of the hydrodehydrogenating phase, in particular for high metals contents (for example, by control of the particle size of transition metal-based particles, maintenance of the properties of said particles after heat treatment, etc);

2) limit the formation of species which are refractory to sulphurization (for example by obtaining a better synergistic effect between the constituent transition metals of the active phase, by control of the interactions between the hydrodehydrogenating active phase (and/or its precursors) and the porous support employed, etc).

In particular, it is known to improve the activity of hydrocracking catalysts by modifying the hydrodehydrogenating function or the acid function.

More generally, various studies have led to the development of sulphide phases of hydrotreatment catalysts which are more active. As an example, adding an organic compound to the hydrotreatment catalysts to improve their activity is now well known to the skilled person. Many patents and patent applications describe the use of various families of organic compounds, such as mono-, di- or poly-alcohols which are optionally etherified (WO 96/41848, WO 01/76741, U.S. Pat. No. 4,012,340, U.S. Pat. No. 3,954,673). Catalysts modified with C₂-C₁₄ monoesters have been described in patent applications EP 0 466 568 and EP 1 046 424. The preparation of these prior art hydrotreatment catalysts ends in a heat treatment carried out at a temperature which is sufficiently low not to decompose the organic compounds used during the preparation before employing said catalysts in a hydrotreatment process.

However, those modifications provided by impregnation of organic compounds during the preparation cannot always increase the catalyst performance sufficiently. In addition, any other synthesis methodologies leading to innovative interactions between an oxide support and the precursors of the active phases are extremely interesting.

### SUMMARY AND ADVANTAGE OF THE INVENTION

The present invention concerns a process for hydrocracking a hydrocarbon feed at least 20% of the volume of which comprises compounds with a boiling point of 340° C. or more, said process consisting of bringing said hydrocarbon cut into contact with at least one catalyst comprising at least one acidic support and at least one active phase formed from at least one metal from group VIII and at least one metal from group VIB, said catalyst being prepared in accordance with a process comprising at least the following in succession:

i) at least one of the steps selected from:

i1) at least one step for bringing at least one pre-catalyst comprising at least said metal from group VIII, at least said metal from group VIB and at least said acidic support into contact with at least one organic compound formed from at least one cyclic oligosaccharide composed of at least 6α-(1,4)-bonded glucopyranose subunits;

i2) at least one step for bringing at least said acidic support into contact with at least one solution containing at least one precursor of at least said metal from group VIII, at least one precursor of at least said metal from group VIB and at least one organic compound formed from at least one cyclic oligosaccharide composed of at least 6α-(1,4)-bonded glucopyranose subunits; and

i3) at least one first step for bringing at least said acidic support into contact with at least one organic compound formed from at least one cyclic oligosaccharide composed of at least 6α-(1,4)-bonded glucopyranose subunits followed by at least one second step for bringing the acidic solid derived from said first step into contact with at least one precursor of at least said metal from group VIII and at least one precursor of at least said metal from group VIB;

ii) at least one drying step;

iii) at least one heat treatment step to decompose said organic compound; and

iv) at least one sulphurization step such that the active phase is in the sulphide form.

Surprisingly, it has been discovered that a supported sulphide catalyst the active phase of which comprises at least one metal from group VIII and at least one metal from group VIB prepared in the presence of at least one organic compound formed from at least one cyclic oligosaccharide composed of at least 6α-(1,4)-bonded glucopyranose subunits, preferably a cyclodextrin, when it is employed in a process for hydrocracking a hydrocarbon cut wherein at least 20% by volume comprises compounds with a boiling point of 340° C. or more, produces improved catalytic performances, especially in terms of catalytic activity and/or in terms of selectivity for middle distillates corresponding to kerosene and gas oil cuts.

### DESCRIPTION OF THE INVENTION

The present invention concerns a process for hydrocracking a hydrocarbon feed at least 20% of the volume of which comprises compounds with a boiling point of 340° C. or more, said process consisting of bringing said hydrocarbon cut into contact with at least one catalyst comprising at least one acidic support and at least one active phase formed from at least one metal from group VIII and at least one metal from group VIB, said catalyst being prepared in accordance with a process comprising at least the following in succession:

i) at least one of the steps selected from:

i1) at least one step for bringing at least one pre-catalyst comprising at least said metal from group VIII, at least said metal from group VIB and at least said acidic support into contact with at least one organic compound formed from at least one cyclic oligosaccharide composed of at least 6α-(1,4)-bonded glucopyranose subunits;

i2) at least one step for bringing at least said acidic support into contact with at least one solution containing at least one precursor of at least said metal from group VIII, at least one precursor of at least said metal from group VIB and at least one organic compound formed from at least one cyclic oligosaccharide composed of at least 6α-(1,4)-bonded glucopyranose subunits; and

i3) at least one first step for bringing at least said acidic support into contact with at least one organic compound formed from at least one cyclic oligosaccharide composed of at least 6α-(1,4)-bonded glucopyranose subunits followed by at least one second step for bringing the acidic solid derived from said first step into contact with at least one precursor of at least said metal from group VIII and at least one precursor of at least said metal from group VIB;

ii) at least one drying step;

iii) at least one heat treatment step to decompose said organic compound; and

iv) at least one sulphurization step such that the active phase is in the sulphide form.

The hydrocarbon feed treated using the hydrocracking process of the invention is a feed wherein at least 20% by volume, preferably at least 80% by volume corresponds to compounds with a boiling point of 340° C. or more.

Said hydrocarbon feed is advantageously selected from LCO (light cycle oil (light gas oils derived from a catalytic cracking unit)), atmospheric distillates, vacuum distillates, for example gas oils derived from straight-through distillation of crude oil or from conversion units such as FCC, the coker or visbreaking, feeds deriving from aromatics extraction units, lubricating base oils or bases derived from solvent dewaxing of lubricating base oils, distillates deriving from processes for fixed or ebullated bed desulphurization or hydroconversion of AR (atmospheric residues) and/or VR (vacuum residues) and/or deasphalted oils, or the feed may be a deasphalted oil or may comprise vegetable oils or may even derive from the conversion of feeds derived from biomass. Said hydrocarbon feed treated using the hydrocracking process of the invention may also be a mixture of said feeds cited above. In accordance with the invention, any feed with a boiling point T5 of more than 340° C., preferably more than 370° C., i.e. such that 95% by weight of the compounds present in said feed have a boiling point of more than 340° C. and preferably more than 370° C., is suitable for carrying out the hydrocracking process of the invention. The hydrocarbon compounds present in said feed are aromatic compounds, olefinic compounds, naphthenic compounds and/or paraffinic compounds.

Said hydrocarbon feed advantageously comprises heteroatoms. Preferably, said heteroatoms are selected from nitrogen, sulphur and a mixture of these two elements. When nitrogen is present in said feed to be treated, the nitrogen content is 500 ppm or more, and preferably in the range 500 to 10000 ppm by weight, more preferably in the range 700 to 4000 ppm by weight and still more preferably in the range 1000 to 4000 ppm. When sulphur is present in said feed to be treated, the sulphur content is in the range 0.01% to 5% by weight, preferably in the range 0.2% to 4% by weight and more preferably in the range 0.5% to 3% by weight.

Said hydrocarbon feed may optionally advantageously contain metals, in particular nickel and vanadium. The cumulative quantity of nickel and vanadium in said hydrocarbon feed treated using the hydrocracking process of the invention is preferably less than 1 ppm by weight. The asphaltenes content of said hydrocarbon feed is generally less than 3000 ppm, preferably less than 1000 ppm, and more preferably less than 200 ppm.

The catalyst, termed a hydrocracking catalyst used to carry out said hydrocracking process of the invention comprises at least one active phase formed from at least one metal from group VIII of the periodic classification of the elements and at least one metal from group VIB of the periodic classification of the elements, said metal(s) from group VIII and said metal(s) from group VIB providing the hydrodehydrogenating function of said catalyst.

Preferably, said catalyst advantageously comprises one or more dopants selected from phosphorus, boron and fluorine and a mixture of said elements. Said doping elements provide acidity and can increase the catalytic activity of the metals from groups VIB and VIII. Preferably, the composition of said hydrocracking catalyst comprises phosphorus.

In general, the total quantity of hydrodehydrogenating elements, i.e. of metal(s) from group VIII and metal(s) from group VIB, is more than 10% by weight of oxides of metals from groups VIB and VIII with respect to the total catalyst weight; preferably, it is in the range 10% to 50% by weight of oxides of metals from groups VIB and VIII with respect to the total catalyst weight. The quantity of metal(s) from group VIB is in the range 6% to 40% by weight of oxide(s) of metal(s) from group VIB with respect to the total catalyst weight, preferably in the range 8% to 37% by weight and more preferably in the range 10% to 35% by weight of oxide(s) of metal(s) from group VIB with respect to the total catalyst weight. The quantity of metal(s) from group VIII is in the range 1% to 10% by weight of oxide(s) of metal(s) from group VIII with respect to the total catalyst weight, preferably in the range 1.2% to 9% by weight and more preferably in the range 1.5% to 8% by weight of oxide(s) of metal(s) from group VIII with respect to the total catalyst weight. The percentages by weight of metals from groups VIII and VIB indicated above are expressed with respect to the total weight of catalyst derived from said step iii) of the process for the preparation of the catalyst employed in the hydrocracking process of the invention. Said catalyst is thus in the oxide form.

The metal from group VIB present in the active phase of the catalyst employed in the hydrocracking process of the invention is preferably selected from molybdenum, tungsten and a mixture of these two elements; highly preferably, the metal from group VIB is molybdenum. The metal from group VIII present in the active phase of the catalyst employed in the hydrocracking process of the invention is preferably selected from non-noble metals from group VIII of the periodic classification of the elements. Preferably, said metal from group VIII is selected from cobalt, nickel and a mixture of these two elements; highly preferably, the metal from group VIII is nickel.

In accordance with the invention, the hydrodehydrogenating function is selected from the group formed from a combination of nickel-molybdenum, nickel-molybdenum-tungsten and nickel-tungsten elements.

The molar ratio of the metal(s) from group VIII to the metal(s) from group VIB in the oxide catalyst derived from said step iii) is preferably in the range 0.1 to 0.8, highly preferably in the range 0.15 to 0.6, and still more preferably in the range 0.2 to 0.5.

When the hydrocracking catalyst contains phosphorus as a dopant, the phosphorus content in said oxide catalyst from said step iii) is preferably in the range 0.1% to 10% by weight of P₂O₅, more preferably in the range 0.2% to 8% by weight of P₂O₅, highly preferably in the range 0.3% to 5% by weight of P₂O₅. The molar ratio of phosphorus to the metal(s) from group VIB in the oxide catalyst from said step iii) is 0.05 or more, preferably 0.07 or more, more preferably in the range 0.08 to 0.5.

When the hydrocracking catalyst contains boron as a dopant, the boron content in said oxide catalyst from said step iii) is preferably in the range 0.1% to 10% by weight of boron oxide, more preferably in the range 0.2% to 7% by weight of boron oxide, and highly preferably in the range 0.2% to 5% by weight of boron oxide.

When the hydrocracking catalyst contains fluorine as a dopant, the fluorine content in said oxide catalyst obtained from said step iii) is preferably in the range 0.1% to 10% by weight of fluorine, more preferably in the range 0.2% to 7% by weight of fluorine, highly preferably in the range 0.2% to 5% by weight of fluorine.

The support for the hydrocracking catalyst employed in the hydrocracking process of the invention is an acidic support selected from porous acidic mineral matrixes and porous mineral matrixes containing zeolitic crystals. Said support is formed from at least one oxide. When the support is composed of an acidic porous mineral matrix, said acidic porous mineral matrix is preferably amorphous or of low crystallinity. It is selected from silica-aluminas with a weight content of silica in said support of strictly over 15%, preferably 20% or more, crystalline or not, mesostructured or not, the doped aluminas (especially with boron, fluorine or phosphorus), non-zeolitic crystalline molecular sieves such as silicoaluminophosphates, aluminophosphates, ferrosilicates, titanium silicoaluminates, borosilicates, chromosilicates and aluminophosphates of transition metals (including cobalt).

In addition to at least one of the oxide compounds cited above, the acidic porous mineral matrix may also advantageously comprise at least one simple synthetic or natural clay of the dioctahedral phyllo silicate 2:1 or trioctahedral phyllosilicate 3:1 type such as kaolinite, antigorite, chrysotile, montmorillonite, beidellite, vermiculite, talc, hectorite, saponite or laponite type. Said clays may possibly have been delaminated.

When the support is composed of a porous mineral matrix containing zeolitic crystals, said matrix may or may not be acidic. An acidic mineral matrix advantageously present in the hydrocracking catalyst support is preferably selected from silica-aluminas with a silica content in said support of strictly more than 15% by weight, preferably 20% by weight or more, crystalline or otherwise, mesostructured or otherwise, doped aluminas (especially with boron, fluorine or phosphorus), crystalline non-zeolitic molecular sieves such as silicoaluminophosphates, aluminophosphates, ferrosilicates, titanium silicoaluminates, borosilicates, chromosilicates and aluminophosphates of transition metals (including cobalt). When said support is based on a mineral matrix which is not acidic, said matrix is advantageously selected from transition aluminas, silicalite and silicas especially mesoporous silicas. The term “transition alumina” means an alpha phase alumina, a delta phase alumina, a gamma phase alumina or a mixture of alumina from said various phases.

The zeolitic crystals present in said acidic support are crystals formed from at least one zeolite selected from Y zeolite, fluorinated Y zeolite, Y zeolite containing rare earths, 10 X zeolite, L zeolite, small pore mordenite, large pore mordenite, omega zeolite, NU-10 zeolite, ZSM-5 zeolite, ZSM-48 zeolite, ZSM-22 zeolite, ZSM-23 zeolite, ZBM-30 zeolite, EU-1 zeolite, EU-2 zeolite, EU-11 zeolite, beta zeolite, A zeolite, NU-87 zeolite, NU-88 zeolite, NU-86 zeolite, NU-85 zeolite, IM-5 zeolite, IM-12 zeolite, IZM-2 zeolite and ferrierite. Said zeolitic crystals advantageously have an atomic ratio of the silicon/alumina framework (Si/Al) of more than 3:1. Preferably, said crystals are formed from at least one zeolite with structure type FAU, especially a stabilized or ultra-stabilized (USY) Y zeolite or in the form which is at least partially exchanged with metallic cations, for example cations of alkaline-earth metals and/or cations of rare earth metals with atomic numbers of 57 to 71 inclusive, or in the hydrogen form (Zeolite Molecular Sieves: Structure, Chemistry and Uses, D W Breck, J Wiley and Sons, 1973).

The pore volume of the acidic support of the catalyst employed in the hydrocracking process of the invention is generally in the range 0.1 to 1.2 cm³/g, preferably in the range 0.2 to 1 cm³/g. The specific surface area of the support is generally in the range 50 to 1000 m²/g, preferably in the range 100 to 600 m²/g. Said porous support is shaped such that it advantageously is in the form of beads, extrudates, pellets or irregular and non-spherical agglomerates the specific shape of which may be the result of a crushing step. Advantageously, said support is in the form of beads or extrudates. Said support is highly advantageously calcined at a temperature preferably in the range 300° C. to 600° C. after shaping. In a preferred embodiment, said support comprises, in part, metals from groups VIB and VIII and/or in part, phosphorus and/or at least in part, a dopant.

In accordance with said step i) of the process for preparing a catalyst employed in the hydrocracking process of the invention, said hydrocracking catalyst is prepared in the presence of at least one organic compound formed from at least one cyclic oligosaccharide composed of at least 6α-(1,4)-bonded glucopyranose subunits. A spatial representation of a glucopyranose subunit is given below:

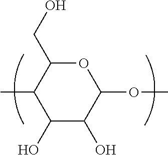

Said organic compound is preferably selected from cyclodextrins, substituted cyclodextrins, polymerized cyclodextrins and mixtures of cyclodextrins. Cyclodextrins are a family of cyclic oligosaccharides composed of α-(1,4)-bonded glucopyranose subunits. They are cage molecules. In accordance with the invention, the cyclodextrins preferably used for carrying out said step i) of the hydrocracking catalyst preparation process, i.e. for carrying out at least one of the steps selected from i1), i2) and i3), are α-cyclodextrin, β-cyclodextrin and γ-cyclodextrin respectively composed of 6, 7 and 8α-(1,4)-bonded glucopyranose subunits. Developed representations of α-cyclodextrin, β-cyclodextrin and γ-cyclodextrin are given below. Preferably, to carry out said step i), β-cyclodextrin is used, composed of 7α-(1,4)-bonded glucopyranose subunits. Cyclodextrins are commercially available compounds.

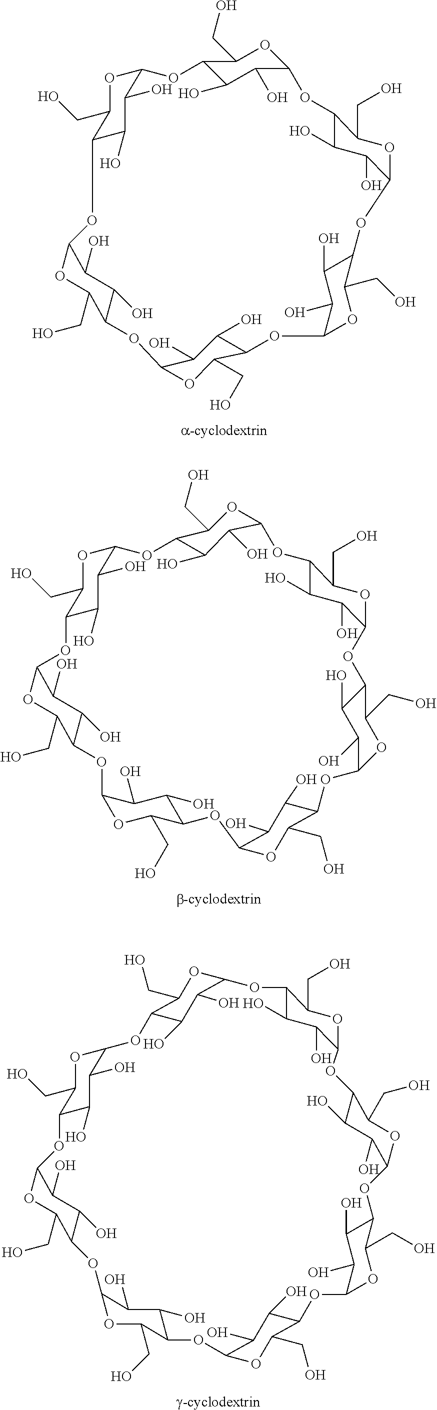 [SMILES: OCC1OC2OC3C(CO)OC(OC4C(CO)OC(OC5C(CO)OC(OC6C(CO)OC(OC7C(CO)OC(OC1C(O)C2O)C(O)C7O)C(O)C6O)C(O)C5O)C(O)C4O)C(O)C3O ; OCC1OC2OC3C(CO)OC(OC4C(CO)OC(OC5C(CO)OC(OC6C(CO)OC(OC7C(CO)OC(OC8C(CO)OC(OC1C(O)C2O)C(O)C8O)C(O)C7O)C(O)C6O)C(O)C5O)C(O)C4O)C(O)C3O ; OCC1OC2OC3C(CO)OC(OC4C(CO)OC(OC5C(CO)OC(OC6C(CO)OC(OC7C(CO)OC(OC8C(CO)OC(OC9C(CO)OC(OC1C(O)C2O)C(O)C9O)C(O)C8O)C(O)C7O)C(O)C6O)C(O)C5O)C(O)C4O)C(O)C3O]

The substituted cyclodextrins advantageously employed to carry out said step i) of the hydrocracking catalyst preparation process, i.e. to carry out at least one of the steps selected from i1), i2) and i3), are constituted by 6, 7 or 8α-(1,4)-bonded glucopyranose subunits, wherein at least one is mono- or polysubstituted. The substituents may be attached to one or more hydroxyl group(s) present in the molecule, namely to hydroxyl groups bonded directly to the cycle of a glucopyranose unit and/or to the hydroxyl bonded to the CH₂ group itself bonded to the cycle of a glucopyranose unit. More preferably, said substituted cyclodextrins carry one or more substituents, which may be identical or different, selected from saturated or unsaturated alkyl radicals, which may or may not be functionalized, and ester, carbonyl, carboxyl, carboxylate, phosphate, ether, polyether, urea, amide, amine, triazole or ammonium functions. Preferred substituted cyclodextrins are methylated, ethylated, propylated and allyl (i.e. having a function with the semi-developed formula —CH₂—CH═CH₂) cyclodextrins, succinylated (i.e. having a function with the semi-developed formula R—OCO—CH₂—CH₂COOH) cyclodextrins, carboxylated, carboxymethylated, acetylated, 2-hydroxpropylated and polyoxyethylenated cyclodextrins. The cyclodextrin mono- or poly-substituents may also be a monosaccharide or disaccharide molecule such as a molecule of maltose, glucose, fructose or saccharose.

Particularly advantageous substituted cyclodextrins for carrying out said step i) of the hydrocracking catalyst preparation process, i.e. for carrying out at least one of the steps selected from i1), i2) and i3), are hydroxypropyl beta-cyclodextrin and methylated beta-cyclodextrins.

The polymerized cyclodextrins which are advantageously employed for carrying out said step i), i.e. for carrying out at least one of the steps selected from i1), i2) and i3), are polymers wherein the monomers are each constituted by a cyclic oligosaccharide composed of 6, 7 or 8α-(1,4)-bonded glucopyranose subunits, which may or may not be substituted. A cyclodextrin in the polymerized form, cross-linked or not, which may advantageously be used to carry out said step i) is, for example, of the type obtained by polymerization of monomers of beta-cyclodextrin with epichlorhydrin or a polyacid.

Advantageous mixtures of cyclodextrins employed in carrying out said step i) of the process for the preparation of the hydrocracking catalyst employ substituted or unsubstituted cyclodextrin. Said mixtures could, for example, contain each of the three types of cyclodextrins (alpha, beta and gamma) jointly and in varying proportions.

Introduction of said organic compound, preferably a cyclodextrin and highly preferably beta cyclodextrin, for carrying out said step i) of the process for the preparation of a hydrocracking catalyst is such that the molar ratio {(metals from groups (VIII+VIB) in the oxide form present in the active phase of the catalyst obtained at the end of said step iii)/organic compound} is in the range 10 to 300, preferably in the range 25 to 180. The metals from groups VIII and VIB taken into account for the calculation of said molar ratio are the metals introduced to carry out said step i) of the process for the preparation of the hydrocracking catalyst and are in the oxide form in the active phase of the catalyst obtained from said step iii). Said metals from groups VIII and VIB may as a consequence be found in the sulphide form: they will be sulphurized prior to carrying out the hydrocracking process described below in the present description.

Contact of said organic compound with said pre-catalyst to carry out said step i1) or respectively with said support for carrying out said step i2) or said step i3) is carried out by impregnation, especially by dry impregnation or excess impregnation, preferably by dry impregnation. Said organic compound is preferably impregnated onto said pre-catalyst (step i1), or respectively onto said support (step i2) or step i3)) after dissolving in an aqueous solution. Impregnation of said organic compound onto said pre-catalyst (step i1)) or respectively onto said support (step i2) or step i3)) is followed by a maturation step then a drying step, preferably carried out at a temperature in the range 50° C. to 200° C., highly preferably in the range 65° C. to 180° C. and still more preferably in the range 75° C. to 160° C. Said drying step is optionally followed by a calcining step.

In accordance with said step i) of the process for the preparation of a hydrocracking catalyst, deposition of at least said metal from group VIII and at least said metal from group VIB onto said support (step i1) or step i2)) or onto said solid comprising said organic compound obtained at the end of said first step in accordance with step i3) may be carried out using any method which is well known to the skilled person, preferably by impregnation of said support (step i1) or step i2)) or of said solid (step i3) by at least one precursor of said metal from group VIII and at least one precursor of said metal from group VIB present in solution. It may be dry impregnation or excess impregnation using methods which are well known to the skilled person. Preferably, dry impregnation is carried out, consisting of bringing said support (step i1) or step i2)) or said solid (step i3)) into contact with at least one precursor of said metal from group VIII and at least one precursor of said metal from group VIB present in one or more solutions the total volume of which is equal to the pore volume of the support to be impregnated or of said solid to be impregnated. Said solution(s) contain(s) metallic precursors of the metal from group VIII and of the metal from group VIB at the desired concentration to obtain the desired concentration of hydrodehydrogenating elements in the active phase of the catalyst. Each step for impregnation of said support (step i1) or step i2)) or said solid (step i3) by at least one precursor of said metal from group VIII and at least one precursor of said metal from group VIB is preferably followed by a maturation step, then by a drying step preferably carried out at a temperature in the range 50° C. to 200° C., highly preferably in the range 65° C. to 180° C. and still more preferably in the range 75° C. to 160° C. Said drying step is optionally followed by a calcining step.

Said metal(s) from group VIII and said metal(s) from group VIB are brought into contact with said support (step i1) or step i2)) or respectively said solid (step i3) using any metallic precursor which is soluble in aqueous phase or in an organic phase. Preferably, said precursor(s) of said metal(s) from group VIII and said precursor(s) of said metal(s) from group VIII are introduced in aqueous solution.

The precursors of said metal(s) from group VIII are advantageously selected from oxides, hydroxides, hydroxycarbonates, carbonates and nitrates of elements from group VIII. Nickel hydroxycarbonate, nickel nitrate, cobalt nitrate, nickel carbonate or nickel hydroxide, cobalt carbonate or cobalt hydroxide are preferably used.

The molybdenum precursors used to carry out said step i) of the hydrocracking catalyst preparation process are well known to the skilled person. As an example, the sources of molybdenum include oxides and hydroxides, molybdic acids and their salts, in particular ammonium salts such as ammonium molybdate, ammonium heptamolybdate, phosphomolybdic acid (H₃PMo₁₂O₄₀) and their salts, and possibly silicomolybdic acid (H₄SiMo₁₂O₄₀) and corresponding salts. The molybdenum sources may also be any other heteropolycompound of the Keggin, lacunary Keggin, substituted Keggin, Dawson, Anderson or Strandberg type, for example. Preferably, molybdenum trioxide and heteropolyanions of the Strandberg, Keggin, lacunary Keggin or substituted Keggin type which are known to the skilled person are used.

The tungsten precursors used to carry out said step i) of the hydrocracking catalyst preparation process are well known to the skilled person. As an example, the sources of tungsten include oxides and hydroxides, tungstic acids and their salts, in particular ammonium salts such as ammonium tungstate, ammonium metatungstate, phosphotungstic acid (H₃PW₁₂O₄₀) and their salts, and possibly silicotungstic acid (H₄SiW₁₂O₄₀) and its salts. The tungsten sources may also be any other heteropolycompound of the Keggin, lacunary Keggin, substituted Keggin or Dawson type, for example. Preferably, ammonium oxides and salts such as ammonium metatungstate or heteropolyanions of the Keggin, lacunary Keggin or substituted Keggin type which are known to the skilled person are used.

The hydrocracking catalyst preparation process employed in the hydrocracking process of the invention comprises several implementations.

In accordance with said step i1) of the catalyst preparation process, a first implementation consists of bringing at least one pre-catalyst comprising at least one metal from group VIII, at least one metal from group VIB and at least one acidic support formed from at least one oxide into contact with at least one organic compound formed from at least one cyclic oligosaccharide composed of at least 6α-(1,4)-bonded glucopyranose subunits. In accordance with the invention, said first implementation is a “post-impregnation” preparation.

In a first variation of said step i1), the pre-catalyst is prepared by depositing at least said metal from group VIII and at least said metal from group VIB onto said support using any method known to the skilled person, preferably by dry impregnation, excess impregnation or by deposition-precipitation using methods well known to the skilled person. The precursors of the metal from group VIB and VIII may be deposited in one or more impregnations. A maturation step is carried out after each step for impregnation said metal from group VIII and VIB. An intermediate drying step, for example carried out at a temperature in the range 50° C. to 200° C. and preferably in the range 75° C. to 160° C., is advantageously carried out between two successive impregnations. After depositing the desired total quantity of metals from groups VIB and VIII, the impregnated solid obtained is dried, for example at a temperature in the range 50° C. to 200° C. and preferably in the range 75° C. to 160° C., and advantageously calcined at a temperature in the range 350° C. to 600° C., preferably in the range 410° C. to 510° C., in order to obtain said pre-catalyst.

In a second variation of said step i1), the pre-catalyst is a catalyst comprising at least one metal from group VIII, at least one metal from group VIB and at least one acidic support formed from at least one oxide, said catalyst having been regenerated to eliminate the coke formed as a result of said catalyst being used in a reaction unit. The spent catalyst is regenerated by combustion of coke, generally by controlling the exothermicity linked to the combustion of the coke. The regenerated catalyst used as a pre-catalyst is then brought into contact with at least one organic compound formed from at least one cyclic oligosaccharide composed of at least 6α-(1,4)-bonded glucopyranose subunits.

Subsequent contact of said organic compound with said pre-catalyst obtained in accordance with the first or second variation of said step i1) is followed by a maturation step then by at least one drying step, which is carried out under the same conditions as those operated for said step ii), and finally by at least one heat treatment step, preferably by at least one calcining step, which is carried out under the same conditions as those operated for said step iii).

A second implementation of the hydrocracking catalyst preparation process consists, in accordance with said step i2), in depositing precursors of said metals from groups VIII and VIB and that of said organic compound onto said support by at least one co-impregnation step, preferably carried out dry. Said second implementation comprises carrying out one or more co-impregnation steps. It is advantageous to carry out impregnation of a portion of the desired total quantity of metals from groups VIB and VIII before or after said co-impregnation step. Each of the co-impregnation steps is followed by a maturation step then by at least one drying step and optionally by at least one calcining step. The last step in depositing the precursors of the metals from groups VIII and VIB and/or said organic compound in order to obtain the hydrocracking catalyst used in the process of the invention, preferably the step for co-impregnation when said second implementation only comprises one co-impregnation step as the impregnation step, is followed by at least one drying step, which is carried out under the same conditions as those operated for said step ii), and finally by at least one heat treatment step, preferably a calcining step, which is carried out under the same conditions as those operated for said step iii).

In accordance with said step i3), a third implementation of the hydrocracking catalyst preparation process consists in bringing at least said support into contact with at least one organic compound formed from at least one cyclic oligosaccharide composed of at least 6α-(1,4)-bonded glucopyranose subunits, then of bringing said support impregnated with said organic compound into contact with at least one precursor of at least said metal from group VIII and at least a precursor of at least said metal from group VIB. The first step for bringing at least said support into contact with said organic compound is preferably immediately followed by a maturation step then by at least one drying step and optionally by at least one calcining step before a second step for bringing the solid from said first step into contact with the precursors of the metals from groups VIB and VIII. Advantageously, said first step is followed by several steps for impregnation of precursors of the metals from groups VIII and VIB. The catalyst preparation in accordance with said third implementation is terminated by at least one drying step, which is carried out under the same conditions as those operated for said step ii), and finally at least one heat treatment step, preferably a calcining step, which is carried out under the same conditions as those operated for said step iii).

In a particular implementation of the hydrocracking catalyst preparation process, a portion of the total quantity of metals from groups VIB and/or VIII present in the active phase of the hydrocracking catalyst is introduced at the time of shaping the support. In particular, said metal(s) from group VIB is (are) introduced at the time of shaping said support in a quantity such that at most 10% by weight, preferably at most 5% by weight of said metal(s) from group VIB present in the active phase of the catalyst are introduced at the time of shaping, the remainder of the quantity of group VIB metals) being introduced when carrying out said step i) of the hydrocracking catalyst preparation process. Advantageously, the metal(s) from group VIB is (are) introduced at the same time as the metal(s) from group VIII.

In accordance with another particular implementation of the hydrocracking catalyst preparation process, the entire quantity of metals from groups VIB and VIII is introduced after shaping and calcining the support when carrying out said step i) of the process for the preparation of said hydrocracking catalyst. Advantageously, the metal(s) from group VIB is (are) introduced at the same time as the metal(s) from group VIII.

The phosphorus which may be present in the active phase of the hydrocracking catalyst is introduced either in its entirety during step i) of the catalyst preparation process or in part when shaping the support, the remainder then being introduced during said step i) of the catalyst preparation process. Highly preferably, the phosphorus is introduced by impregnation of the entire amount or at least a portion during said step i) of the catalyst preparation process and still more preferably, it is introduced as a mixture with at least one of the precursors of the metals from groups VIB and/or VIII during one of the steps selected from steps i1), i2) and i3). Impregnation of phosphorus during said step i) of the catalyst preparation process, in particular when the phosphorus is introduced alone (i.e. in the absence of any other element of the active phase of the catalyst) is followed by a step for drying at a temperature in the range 50° C. to 200° C., preferably in the range 65° C. to 180° C. and more preferably in the range 75° C. to 160° C. The preferred source of phosphorus is orthophosphoric acid, H₃PO₄, however its salts and esters such as ammonium phosphates are also suitable. The phosphorus may also be introduced at the same time as the element(s) from group VIB in the form of Keggin, lacunary Keggin, substituted Keggin or Strandberg type heteropolyanions which are well known to the skilled person.

The dopant(s) which may be present in the active phase of the catalyst in the form of boron and/or fluorine, is (are) introduced either in their entirety during step i) of the process for the preparation of said hydrocracking catalyst or in their entirety during the preparation of the support and preferably during shaping of the support, either still partially during the preparation of the support, the remainder then being introduced during said step i) of the process for the preparation of said hydrocracking catalyst. Highly preferably, the dopant is introduced by impregnation, in its entirety or partially during said step i) of the process for the preparation of the hydrocracking catalyst and still more preferably it is introduced as a mixture with at least one of the precursors of the metals from groups VIB and/or VIII during one of the steps selected from steps i1), i2) and i3). Impregnation of the dopant during said step i) of the hydrocracking catalyst preparation process, in particular when the dopant is introduced alone (i.e. in the absence of any other element of the active phase of the catalyst) is followed by a step for drying at a temperature in the range 50° C. to 200° C., preferably in the range 65° C. to 180° C. and more preferably in the range 75° C. to 160° C. The source of boron may be boric acid, preferably orthoboric acid H₃BO₃, ammonium biborate or pentaborate, boron oxide, or boric esters. The boron may, for example, be introduced using a boric acid solution in a water/alcohol mixture or in a water/ethanolamine mixture. The sources of fluorine which may be used are well known to the skilled person. As an example, fluoride anions may be introduced in the form of hydrofluoric acid or its salts. These salts are formed with alkali metals, ammonium or an organic compound. In this latter case, the salt is advantageously formed from reaction between an organic compound and hydrofluoric acid. The fluorine may be introduced, for example, by impregnation of an aqueous hydrofluoric acid or ammonium fluoride or ammonium difluoride solution.

Said drying step ii) carried out for the hydrocracking catalyst preparation is carried out at a temperature in the range 50° C. to 200° C., preferably in the range 65° C. to 180° C., and still more preferably in the range 75° C. to 160° C. Said step ii) is preferably carried out for a period in the range 1 to 20 hours. Said drying step means that solvent(s) used during said step i) can be evacuated.

Said drying step is followed by at least one heat treatment step iii) to decompose said organic compound formed from at least one cyclic oligosaccharide composed of at least 6α-(1,4)-bonded glucopyranose subunits. Said heat treatment is carried out at a temperature in the range 350° C. to 600° C., preferably in the range 370° C. to 550° C. and more preferably in the range 410° C. to 510° C. It is advantageously carried out in air or in an inert gas in any equipment known to the skilled person for carrying out this type of heat treatment. Preferably, the heat treatment is carried out in air, thereby calcining it. The heat treatment is carried out for a period which is advantageously in the range 1 to 6 hours, preferably in the range 1 to 3 hours.

The catalyst obtained at the end of said step iii) after carrying out steps i) and ii) of the preparation process described above are in the oxide state.

The hydrocracking catalyst preparation process used in the hydrocracking process of the invention comprises at least one step for sulphurization iv) such that the active phase of the catalyst is in the sulphide form in order to use said catalyst in the hydrocracking process as described below in the present description. Said sulphurization step is carried out after carrying out said step iii). This activation treatment by sulphurization is well known to the skilled person and can be carried out using any method known to the skilled person. Said sulphurization step is carried out by bringing said catalyst from said step iii) of the preparation process described above in the present description into contact with at least one decomposable organic sulphur-containing compound that can generate H₂S or by bringing said catalyst into direct contact with a gaseous stream of H₂S, for example diluted in hydrogen. Said sulphur-containing organic compound is advantageously selected from alkyldisulphides such as dimethyldisulphide (DMDS), alkyl sulphides such as dimethyl sulphide, mercaptans such as n-butylmercaptan, polysulphide compounds of the tertiononylpolysulphide type such as TPS-37 or TPS-54 sold by ARKEMA, or any other compound known to the skilled person for obtaining good catalyst sulphurization. Said sulphurization step iv) may be carried out in situ (i.e. after loading the catalyst into the reaction unit for the hydrocracking process of the invention described below in the present description) or ex situ (i.e. before loading the catalyst into the reaction unit of the hydrocracking process of the invention described below in the present description) at a temperature in the range 200° C. to 600° C. and more preferably in the range 300° C. to 500° C.

The catalyst from said step iv) is at least partially in the sulphide form before carrying out the hydrocracking process of the invention. It may also comprise a metallic oxide phase which has not been transformed during said sulphurization step iv). Said catalyst is entirely free of said organic compound formed from at least one cyclic oligosaccharide composed of at least 6α-(1,4)-bonded glucopyranose subunits.

The hydrocracking process of the invention covers pressure and conversion ranges from mild hydrocracking to high pressure hydrocracking. The term “mild hydrocracking” means hydrocracking resulting in moderate conversions, generally less than 40%, and functioning at low pressure, generally 2 MPa to 10 MPa. The hydrocracking process of the invention is carried out in the presence of at least one catalyst obtained at the end of said step iv) of said preparation process described above and using said cyclic oligosaccharide composed of at least 6α-(1,4)-bonded glucopyranose subunits. The hydrocracking process of the invention may be carried out in one or two-steps independently of the pressure at which said process is carried out. It is carried out in the presence of one or more, generally two hydrocracking catalyst(s) obtained using the preparation process described above, in one or more reaction unit(s) equipped with one or more reactor(s).

In a first implementation of the hydrocracking process of the invention, the hydrocracking catalyst(s) obtained at the end of said step iv) of said preparation process employing said cyclic oligosaccharide is (are) advantageously used alone or in a concatenation, in a single or in several catalytic beds, in a fixed bed or ebullated bed, in one or more reactors, in a hydrocracking operation termed “once-through” with or without liquid recycling of the unconverted fraction, and optionally in association with a hydrorefining catalyst located upstream of the hydrocracking catalyst or catalysts. The ebullated bed is operated with removal of spent catalyst and daily addition of fresh catalyst in order to keep the catalyst activity stable.

In a second implementation of the hydrocracking process of the invention, the hydrocracking catalyst(s) obtained at the end of said step iv) of said preparation process employing said cyclic oligosaccharide is (are) advantageously used alone or in a concatenation, in a single or in several catalytic beds in one and/or the other step of a hydrocracking operation termed a “two-step” operation. The “two-step” operation is an operation for which there is intermediate separation of effluents between the two reaction zones. This operation may be operated with or without liquid recycling of the unconverted fraction from the first reaction zone or from the second reaction zone. The first reaction zone is operated in fixed bed or ebullated bed mode. In the particular case in which the hydrocracking catalyst or catalysts obtained using the preparation process employing said cyclic oligosaccharide is to be placed in the first reaction zone, it or they will preferably be placed in association with a hydrorefining catalyst located upstream of said catalysts.

### “Once-Through” Hydrocracking Process

Hydrocracking termed “once-through” comprises in the first place and in general intense hydrorefining which is intended to carry out intense hydrodenitrogenation and desulphurization of the feed before it is sent to the hydrocracking catalysts obtained using the preparation process employing said cyclic oligosaccharide. Said once-through hydrocracking process is particularly advantageous when said hydrocracking catalyst(s) comprise(s) a support comprising zeolite crystals. Said intense hydrorefining of the feed only produces limited conversion of the feed, into lighter fractions, which is insufficient and must therefore be completed over more active hydrocracking catalyst(s), obtained using the preparation process employing said cyclic oligosaccharide. However, it should be noted that no separation of effluents is involved between the various catalytic beds: all of the effluent leaving the hydrorefining catalytic bed is injected onto the catalytic bed or beds containing said hydrocracking catalyst(s) obtained using the preparation process employing said cyclic oligosaccharide, and then separation of the products formed is carried out. This version of hydrocracking has a variation which involves recycling the unconverted fraction to at least one of the hydrocracking catalytic beds with a view to more intense conversion of the feed.

The once-through hydrocracking process of the invention uses, for example, a hydrorefining catalyst placed upstream of a hydrocracking catalyst supported on an alumina containing zeolitic crystals and for which the active phase is based on nickel and molybdenum, said hydrocracking catalyst being obtained by the preparation process employing said cyclic oligosaccharide. The once-through hydrocracking process of the invention may also advantageously be carried out in the presence of a hydrorefining catalyst placed upstream of a first hydrocracking catalyst supported on a silica-alumina and for which the active phase is based on nickel and tungsten and a second hydrocracking catalyst supported on an alumina containing zeolitic crystals and for which the active phase is based on nickel and molybdenum, said hydrocracking catalysts being obtained using the preparation process employing said cyclic oligosaccharide.

### “Two-Step” Hydrocracking Process

“Two-step” hydrocracking comprises a first step which, as in the “once-through” process, is intended to carry out hydrorefining of the feed, but it is also intended to achieve a conversion of the feed which is generally of the order of 40% to 60%. The effluent from the first step then undergoes separation, generally by distillation, usually termed intermediate separation, which is intended to separate the conversion products from the unconverted fraction. In the second step of a two-step hydrocracking process of the invention, only the fraction of feed not converted during the first step is treated. This separation means that the two-step hydrocracking process of the invention is more selective for middle distillates (kerosene+diesel) than the once-through process of the invention. In fact, intermediate separation of the conversion products avoids “over cracking” them to naphtha and gas in the second step on the hydrocracking catalyst(s) obtained using the preparation process described above in the present description. Further, it should be noted that the unconverted fraction of the feed treated in the second step in general contains very low NH₃ contents as well as organic nitrogen-containing compounds, in generally less than 20 ppm by weight or even less than 10 ppm by weight.

In accordance with a preferred implementation of the two-step hydrocracking process of the invention, said first step is carried out in the presence of a hydrorefining catalyst and a hydrocracking catalyst, said hydrocracking catalyst advantageously being supported on a silica-alumina containing zeolitic crystals and for which the active phase is based on nickel and tungsten, and said second step is carried out in the presence of a hydrocracking catalyst with a different composition from that present for carrying out said first step, for example a catalyst supported on an alumina containing zeolitic crystals and for which the active phase is based on nickel and molybdenum, said hydrocracking catalysts being obtained using the preparation process employing said cyclic oligosaccharide.

### Operating Conditions

The hydrocracking process of the invention is carried out under operating conditions (temperature, pressure, hydrogen recycle ratio, hourly space velocity) which may vary greatly as a function of the nature of the feed, the quality of the desired products and the facilities available to the refiner. In accordance with the hydrocracking process of the invention, said hydrocracking catalyst is advantageously brought into contact in the presence of hydrogen with said hydrocarbon feed at a temperature of more than 200° C., often in the range 250° C. to 480° C., advantageously in the range 320° C. to 450° C., preferably in the range 330° C. to 435° C., at a pressure of more than 1 MPa, often in the range 2 to 25 MPa, preferably in the range 3 to 20 MPa, the space velocity (volume flow rate of feed divided by the volume of catalyst) being in the range 0.1 to 20 h⁻¹ and preferably in the range 0.1 to 6 h⁻¹, preferably in the range 0.2 to 3 h⁻¹, and the quantity of hydrogen introduced is such that the volume ratio, litres of hydrogen/litres of hydrocarbon, is in the range 80 to 5000 l/l, usually in the range 100 to 2000 l/l.

These operating conditions used in the hydrocracking process of the invention generally mean that conversions per pass into products with boiling points of at most 370° C. and advantageously at most 340° C. of more than 15% and more preferably in the range 20% to 95% can be obtained.

The following examples illustrate the invention without in any way limiting its scope.

### EXAMPLES

### Example 1

### Preparation of Catalysts C1 (not in Accordance) and C2 (in Accordance)

Two hydrocracking catalysts with formulation NiMo/silica-alumina were prepared from a support in the form of extrudates constituted by a SIRALOX type silica-alumina sold by SASOL with a silica weight content of 25%. Said silica-alumina has a pore volume of 0.7 mug and a specific surface area of 315 m²/g. The metallic precursors used to prepare the catalysts C1 and C2 were ammonium heptamolybdate (HMA) and nickel nitrate Ni(NO₃)₂; these compounds had already been dissolved using a reflux setup for 2 h at 90° C. The clear solution obtained was then concentrated by evaporation of water in order to reach the impregnation volume, then it was dry impregnated at ambient temperature onto the silica-alumina. The concentrations of metallic precursors in the impregnation solution were adjusted in order to deposit the desired weights of Ni and Mo on the silica-alumina support. After dry impregnation, the extrudates were left to mature overnight in a closed water-saturated vessel and were then oven dried at 120° C. for 24 h. A catalytic pre-catalyst was thus obtained which was divided into 2 batches:
the first batch was calcined at 450° C. for 2 h in air in a fixed traversed bed to produce the calcined catalyst C1 (not in accordance). The final composition of catalyst C1, expressed in the oxide form, was as follows: NiO=3.6% by weight, MoO₃=20% by weight. The Ni/Mo molar ratio was equal to 0.35;
the second batch was dry impregnated with an aqueous solution containing β-cyclodextrin (SIGMA ALDRICH, 98% purity) with a (Ni+Mo)/β-cyclodextrin molar ratio of 30 until moisture just appeared, which showed that the pores of the catalytic precursor had been filled with the solution containing the β-cyclodextrin. Next, it was matured for 3 h followed by drying at 120° C. for 1 h then calcining at 450° C. for two hours. The catalyst obtained thereby was the catalyst C2 in accordance with the invention. The composition of catalyst C2 was identical to that of catalyst C1.

### Example 2

### Preparation of Catalysts C3 (not in Accordance) and C4 (in Accordance)

Two hydrocracking catalysts with formulation NiMoP/(alumina+zeolitic crystals) were prepared. The support was constituted by gamma alumina containing 19.2% by weight of Y zeolite (% by weight with respect to the support) having an atomic ratio Si/Al equal to 15. The alumina had a pore volume of 0.62 ml/g and a specific surface area of 400 m²/g. The metallic precursors used to prepared the catalysts C3 and C4 were MoO₃, Ni(OH)₂ and H₃PO₄; these compounds had already been dissolved using a reflux setup for 2 h at 90° C. The clear solution obtained was then concentrated by evaporation of water in order to reach the impregnation volume, then it was dry impregnated at ambient temperature onto the support (alumina+zeolitic crystals). The concentrations of metallic precursors in the impregnation solution were adjusted in order to deposit the desired weights of Ni, Mo and P on the silica-alumina support. After dry impregnation, the extrudates were left to mature overnight in a closed water-saturated vessel and were then oven dried at 120° C. for 24 h. A catalytic pre-catalyst was thus obtained which was divided into 2 batches:
the first batch was calcined at 450° C. for 2 h in air in a fixed traversed bed to produce the calcined catalyst C3 (not in accordance). The final composition of catalyst C3, expressed in the oxide form, was as follows: NiO=3.5% by weight, MoO₃=18.5%, P₂O₅=4.2% by weight. The Ni/Mo molar ratio was equal to 0.37 and the P/Mo molar ratio was equal to 0.46;
the second batch was dry impregnated with an aqueous solution containing β-cyclodextrin (SIGMA ALDRICH, 98% purity) with a (Ni+Mo)/β-cyclodextrin molar ratio of 30 until moisture just appeared, which showed that the pores of the catalytic precursor had been filled with the solution containing the β-cyclodextrin. Next, it was matured for 3 h followed by drying at 125° C. for 2 h then calcining at 450° C. for two hours. The catalyst obtained thereby was the catalyst C4 in accordance with the invention. The composition of catalyst C4 was identical to that of catalyst C3.

### Example 3

### Evaluation of Catalysts C1 and C3 (not in Accordance) and C2 and C4 (in Accordance) by Hydrogenation of Toluene in the Presence of Aniline

The test for the hydrogenation of toluene in the presence of aniline (HTA test) is intended to evaluate the hydrogenating activity (HYD) of supported sulphur-containing catalysts in the presence of H₂S and under hydrogen. The isomerization and cracking which characterizes the acid function of a hydrocracking catalyst are inhibited by the presence of NH₃ (following decomposition of aniline); thus, the HTA test means that the hydrogenating power of each of the test catalysts can be specifically determined. The aniline and/or NH₃ will thus react by an acid-base reaction with the acid sites of the support. Each HTA test was carried out on a unit comprising several micro-reactors in parallel. For each “HTA” test, the same feed was used to sulphurize the catalyst and for the catalytic test phase proper. Before loading, the catalyst was conditioned: it was sorted so that the length of the extrudates was in the range 2 to 4 mm. 4 cm³ of sorted catalyst mixed with 4 cm³ of carborundum (SiC, 500 μm) were loaded into the reactors.

The feed used for this test was as follows:

| | |
|---|---|
| toluene | 20% by weight |
| cyclohexane | 73.62% by weight |
| DMDS (dimethyldisulphide) | 5.88% by weight (3.8% by weight of S) |
| Aniline | 0.5% by weight (750 ppm N) |

The catalyst was loaded into the reactor in its oxide, inactive, form. Activation (sulphurization) was carried out in the unit with that same feed. The H₂S which is formed following decomposition of DMDS sulphurizes the oxide phase. The quantity of aniline present in the feed was selected to obtain approximately 750 ppm of NH₃ after decomposition.

The operating conditions for the toluene hydrogenation test were as follows:
P=6 MPa;
HSV=2 h⁻¹ (feed flow rate=8 cm³/h);
H₂/HC=450 Nl/l (H₂ stream=3.6 Nl/l);
T=350° C.

The percentage of the toluene converted was evaluated and, by assuming that the reaction was first order, the activity was deduced using the following relationship:

$$Λ {H}_{1 st order} = ln \frac{100}{( 100 - \% H Y {D}_{toluene} )}$$

where % HYDₜₒₗᵤₑₙₑ=percentage of toluene converted.

The activity of catalyst C1 was taken as the reference and was equal to 100. The results obtained are summarized in Table 1.

TABLE 1
Relative hydrogenating activity of catalysts C1, C2, C3 and C4

| | | | Heat | |
|---|---|---|---|---|
| | | | treatment | Hydrogenating |
| | | | after adding | activity (based |
| | Initial | Organic | organic | on 100 for |
| Catalyst | catalyst | additive | additive | catalyst C1) |
| C1, not in | — | — | — | 100 |
| accordance | | | | |
| (NiMo on | | | | |
| Siralox) | | | | |
| C2, in | C1 | β-cyclodextrin | Drying | 121 |
| accordance | | | 125° C. | |
| (NiMo on | | | Calcining | |
| Siralox) | | | 450° C. | |
| C3, not in | — | — | — | 114 |
| accordance | | | | |
| (NiMoP on | | | | |
| alumina + | | | | |
| zeolite) | | | | |
| C4, in | C2 | β-cyclodextrin | Drying | 132 |
| accordance | | | 125° C. | |
| (NiMoP on | | | Calcining | |
| alumina + | | | 450° C. | |
| zeolite) | | | | |

The results shown in Table 1 demonstrate that catalysts C2 and C4 prepared in the presence of β-cyclodextrin have a substantially improved hydrogenating activity with respect to that of catalysts C1 or respectively C3 prepared in the absence of β-cyclodextrin. The improvement in hydrogenating activity encourages the improvement in the selectivity of catalysts C2 and C4 for middle distillates which are the desired products.

### Example 4

### Mild VD Hydrocracking Evaluation of Catalysts C1 (not in Accordance) and C2 (in Accordance)

The feed used was a vacuum distillate feed “VD” the principal characteristics of which are summarized in Table 2.

TABLE 2
Characteristics of VD used for mild hydrocracking

| | |
|---|---|
| Feed | VD |
| Density 15/4 (g/cm³) | 0.897 |
| Organic S (wt %) | 0.2104 |
| Organic N (ppm) | 399 |
| WMT* (° C.) | 467 |
| Volume % of compounds with boiling | 13.2 |
| point below 370° C. | |

*Weighted mean temperature = (1T_{5%} + 2T_{50%} + 4T_{95%})/7, where T_{x%} corresponds to the boiling point of the x % by weight of hydrocarbon compounds present in the liquid cut.

A fraction of the extrudates of catalysts C1 and C2 with a length in the range 2 to 4 mm was successively tested. 4 cm³ of catalyst C1 in the oxide form then catalyst C2 in the oxide form were loaded in the reactor. Activation (sulphurization) was carried out in the reaction unit before starting the test with a “sulphurization” feed (straight run gas oil+2% by weight DMDS). The H₂S formed following decomposition of DMDS sulphurizes the catalysts C1 and C2.

The operating conditions applied during the test were as follows:
P=6 MPa;
HSV=0.6 h⁻¹;
H₂HCₒᵤₜₗₑₜ=480 Nl/l;
T=380° C.

The catalytic results are summarized in Table 3. The gross conversion corresponds to the conversion of the hydrocarbon fraction with a boiling point of more than 370° C. present in the initial VD feed into hydrocarbons with a boiling point of less than 370° C. and present in the effluent. The gross conversion is determined as being equal to the weight fraction constituted by the hydrocarbons with a boiling point of less than 370° C. and present in the effluent.

TABLE 3
Catalytic performances obtained for C1 and C2 for mild hydrocracking

| | | Total sulphur in effluent |
|---|---|---|
| | Gross conversion (%) | (ppm) |
| C1 (not in accordance) | 32 | 60 |
| C2 (in accordance) | 35 | 41 |

The catalyst C2 prepared in the presence of β-cyclodextrin not only resulted in a 3% conversion gain but also in a substantial reduction in the quantity of sulphur compared with the catalyst C1 prepared in the absence of O-cyclodextrin (not in accordance). These results show that in addition to a gain in hydrogenation illustrated in Example 3, the catalyst C2 can produce important gains in activity for mild hydrocracking compared with a conventional catalyst. Catalyst C2 is more active than catalyst C1.

### Example 5

### High Pressure VD Hydrocracking Evaluation of Catalysts C3 (not in Accordance) and C4 (in Accordance)

The unit which was used operated in “once-through” (1-step) mode with no liquid recycle. The reaction unit was loaded with 50 cm³ of catalyst for each test. The feed prior to injection was kept at a temperature of 70° C. in a closed thermal vessel. The fluids (feed+hydrogen) in the reactor moved in upflow mode. Stripping of the hydrogen receipts (flow rate of 20 l/h) was carried out and the gaseous effluents from the gas/liquid separator and the stripper were counted and analyzed by in-line gas chromatography. The activation feed (sulphurization) was a gas oil to which 2% by weight of dimethyldisulphide (DMDS) and 2% by weight of aniline had been added. The test feed was a hydrotreated and supplemented VD feed as described in Tables 4 and 5.

TABLE 4
Characteristics of feed before supplementing

| Initial feed | VD |
|---|---|
| Organic S (wt %) | 12 |
| Organic N (ppm) | 7.0 |
| Aromatics (wt %) | 15.4 |
| Density 15° C. | 0.861 |
| WMT* (° C.) | 438.4 |

*Weighted mean temperature = (1T_{5%} + 2T_{50%} + 4T_{95%})/7, where T_{x%} corresponds to the boiling point of the x % by weight of hydrocarbon compounds present in the liquid cut.

Of the order of 2.8% of sulphur in the form of DMDS and of the order of 1250 ppm of nitrogen in the form of aniline were added to the initial VD feed. The DMDS and the aniline decomposed in the hydrocracking reactor to result in the formation of NH₃ and H₂S. The characteristics of the feed after supplementing are given in Table 5.

TABLE 5
Characteristics of feed after supplementing

| | |
|---|---|
| Density 15° C. | 0.870 |
| Sulphur (wt %) | 2.79 |
| Nitrogen (ppm) | 1220 |
| Refractive index | 1.456 |
| Distillation | |
| Bp ≦150° C. | 2.7% by weight |
| Bp ≦250° C. | 9.6% by weight |
| Bp ≦370° C. | 31.0% by weight |

The operating conditions applied during the test were as follows:
P=14 MPa;
HSV=1 h⁻¹;
H₂/HCₒᵤₜₗₑₜ=1000 Nl/l;
T=385° C.

The startup protocol was as follows:
at ambient temperature, the catalyst was moistened with the activation feed (sulphurization) then the hydrogen was injected with the activation feed. The temperature was then increased;
at the end of the sulphurization stage at 350° C., the activation feed was replaced by the supplemented VD feed and the temperature was adjusted to the reaction temperature, i.e. 385° C.;
after replacing the activation feed with the supplemented VD feed, the feed and hydrogen flow rates were adjusted to obtain the desired values.

This test allowed catalysts C3 and C4 to be compared by determining:
the gross conversion of the 370° C.+ fraction (hydrocarbon compounds with a boiling point of more than 370° C.) into 370° C.− (hydrocarbon compounds with a boiling point of less than 370° C.: gross conversion into 370° C.−=% by weight 370° C.−_{effluents} The definition of the gross conversion was similar to that of Example 4;
the gross selectivity for middle distillates (gas oil+kerosene): gross selectivity for middle distillates=(wt %(150-370° C.)_{effluents})/gross conversion into 370° C. The gross selectivity for middle distillates was determined to be equal to the weight fraction constituted by hydrocarbons with a boiling point in the range 150° C. to 370° C. present in the effluents divided by the gross conversion of the 370° C.+ fraction into 370° C.−.

The results are summarized in Table 6.

TABLE 6
Catalytic performances obtained for catalysts C3 and C4 for high
pressure hydrocracking

| | | Selectivity for middle |
|---|---|---|
| | Gross conversion (%) | distillates (wt %) |
| C3 (not in accordance) | 88 | 61 |
| C4 (in accordance) | 88 | 63 |

The catalytic results show that at a temperature of 385° C., the conversion obtained by the two catalysts C3 (not in accordance) and C4 (in accordance) were identical and that the selectivity for the desired products, namely middle distillates (cut with a boiling point in the range 150° C. and 370° C., gas oil+kerosene) is greater for the catalyst C4 prepared in the presence of β-cyclodextrin. Thus, catalyst C4 was as active as the catalyst C3 and more selective for the desired products than the catalyst C3. This result is particularly important in the context of a global fuel market which is moving towards diesel. This result is also entirely in agreement with that of Example 3, demonstrating that the hydrogenating activity of catalyst C4 is greater than that of catalyst C3.

1. A process for hydrocracking a hydrocarbon feed at least 20% of the volume of which comprises compounds with a boiling point of 340° C. or more, said process consisting of bringing said hydrocarbon cut into contact with at least one catalyst comprising at least one acidic support and at least one active phase formed from at least one metal from group VIII and at least one metal from group VIB, said catalyst being prepared in accordance with a process comprising at least the following in succession:
i) at least one of the steps selected from:
i1) at least one step for bringing at least one pre-catalyst comprising at least said metal from group VIII, at least said metal from group VIB and at least said acidic support into contact with at least one organic compound formed from at least one cyclic oligosaccharide composed of at least 6α-(1,4)-bonded glucopyranose subunits;
i2) at least one step for bringing at least said acidic support into contact with at least one solution containing at least one precursor of at least said metal from group VIII, at least one precursor of at least said metal from group VIB and at least one organic compound formed from at least one cyclic oligosaccharide composed of at least 6α-(1,4)-bonded glucopyranose subunits; and
i3) at least one first step for bringing at least said acidic support into contact with at least one organic compound formed from at least one cyclic oligosaccharide composed of at least 6α-(1,4)-bonded glucopyranose subunits followed by at least one second step for bringing the acidic solid derived from said first step into contact with at least one precursor of at least said metal from group VIII and at least one precursor of at least said metal from group VIB;
ii) at least one drying step;
iii) at least one heat treatment step to decompose said organic compound; and
iv) at least one sulphurization step such that the active phase is in the sulphide form.

2. A hydrocracking process according to claim 1, in which said hydrocarbon feed comprises heteroatoms selected from nitrogen, sulphur and a mixture of said two elements.

3. A hydrocracking process according to claim in which said catalyst comprises one or more dopants selected from phosphorus, boron and fluorine and a mixture of said elements.

4. A hydrocracking process according to claim 1, in which said metal from group VIB is selected from molybdenum, tungsten and a mixture of said two elements.

5. A hydrocracking process according to claim 1, in which said metal from group VIII is selected from cobalt, nickel and a mixture of said two elements.

6. A hydrocracking process according to claim 1, in which said acidic support is selected from acidic porous mineral matrices and porous mineral matrices containing zeolitic crystals.

7. A hydrocracking process according to claim 1, in which said organic compound is selected from cyclodextrins, substituted cyclodextrins, polymerized cyclodextrins and a mixture of cyclodextrins.

8. A hydrocracking process according to claim 7, in which the cyclodextrins are α-cyclodextrin, β-cyclodextrin and γ-cyclodextrin respectively composed of 6, 7 and 8α-(1,4)-bonded glucopyranose subunits.

9. A hydrocracking process according to claim 7, in which the substituted cyclodextrins are hydroxypropyl beta-cyclodextrin and methylated beta-cyclodextrins.

10. A hydrocracking process according to claim 1, in which said organic compound for carrying out said step i) is introduced such that the molar ratio {(metals from groups (VIII+VIB) in the oxide form present in the active phase of the catalyst obtained from said step iii)/organic compound} is in the range 10 to 300.

11. A hydrocracking process according to claim 1, in which said drying step ii) is carried out at a temperature in the range 50° C. to 200° C.

12. A hydrocracking process according to claim 1, in which said heat treatment step iii) is carried out at a temperature in the range 350° C. to 600° C.

13. A hydrocracking process according to claim 1, in which said hydrocracking catalyst is brought into contact, in the presence of hydrogen, with said hydrocarbon feed at a temperature of more than 200° C., at a pressure of more than 1 MPa, the hourly space velocity (volume flow rate of feed divided by the volume of catalyst) being in the range 0.1 to 20 h⁻¹ and the quantity of hydrogen introduced being such that the volume ratio of litres of hydrogen/litres of hydrocarbon is in the range 80 to 5000 l/l.

14. A hydrocracking process according to claim 1, carried out in one or two-steps independently of the pressure at which said process is carried out.
